(19) United States
(12) Patent Application Publication
(10) Pub. No.: US 2014/0097773 A1
(43) Pub. Date: Apr. 10, 2014

(54) METHOD AND DEVICE FOR OPERATING AN ELECTRONICALLY COMMUTATED ELECTRIC MACHINE

(71) Applicant: Torsten Wilharm, Buehl (DE)

(72) Inventor: Torsten Wilharm, Buehl (DE)

(73) Assignee: ROBERT BOSCH GMBH, Stuttgart (DE)

(21) Appl. No.: 14/118,363

(22) PCT Filed: May 9, 2012
(86) PCT No.: PCT/EP2012/058483

§ 371 Date: Nov. 18, 2013

(30) Foreign Application Priority Data
May 20, 2011 (DE) 10 2011 076 164.0

(51) Int. Cl. H02P 6/14

(52) U.S. Cl. CPC H02P 6/14
USPC 318/400.2

(57) ABSTRACT

The invention relates to a method for operating a multi-phase electric machine (2), wherein control voltages (U_{A}, U_{B}, U_{C}) to be applied to phase windings of the electric machine (2) are provided according to a predefined commutation method, wherein, if a sudden change in state as defined by the predefined commutation method is detected from a state in which one of the phase windings is switched off to a state in which the control voltage (U_{A}, U_{B}, U_{C}) is applied to the relevant phase winding, the following steps are carried out: immediate application of a provided intermediate voltage (U_{Z}); and application of a voltage profile produced from a predefined, chronological, constant profile from the intermediate voltage (U_{Z}) to the control voltage (U_{A}, U_{B}, U_{C}) of the relevant phase winding, until the control voltage (U_{A}, U_{B}, U_{C}) to be applied is reached.

### BACKGROUND OF THE INVENTION

The invention relates to electric machines, in particular to drive methods for operating electronically commutated electric machines. The invention also relates to commutation methods for electronically commutated electric machines.

Electronically commutated electric machines are often operated by applying drive voltages to the phase connections of said electric machines such that stator windings of the electric machine are energized. The drive voltages change over time and thus form an AC voltage, which produces a stator magnetic field which corresponds to a traveling magnetic field or, in the case of rotary machines, a rotating magnetic field.

The stator magnetic field interacts with an exciter magnetic field produced by a rotor of the electric machine, with the result that a drive force or a drive torque for driving the rotor is effected. The drive force or the drive torque is dependent on the relative position of the stator magnetic field produced by the applied drive voltages and the exciter magnetic field with respect to one another. For the operation of the electric machine, the drive voltages are therefore applied, depending on a rotor position of the rotor, in such a way that the direction of the resulting stator magnetic field has a lead with respect to the exciter magnetic field.

The generation of the drive voltages to be applied can be performed using various types of commutation. An inexpensive implementation of commutation of the drive voltages consists in so-called block commutation, in which, during a time window determined by the movement speed of the rotor, constant drive voltages are applied to the phase connection of the electric machine and, after the time window, a correspondingly different combination of drive voltages is applied.

The block commutation can be implemented inexpensively since it only requires a simple microcontroller to provide switching patterns for the application of the drive voltages. The changes in the individual drive voltages generally take place abruptly in the case of block commutation, however, as a result of which considerable running noise of the electric machine can occur.

In order to improve the noise level of the electric machine, a further type of commutation referred to as trapezoidal commutation is known, in which the application of the drive voltage to the phase connections is performed in the same way, but the magnitudes of the gradients of the voltage edges occurring as a result of the changes in the drive voltages are limited, so that a trapezoidal signal profile of the drive voltages results in a voltage/time graph. As a result, the transitions in the case of the changes of the stator magnetic field can be softer, as a result of which the running noise is reduced.

If an electric machine is intended to be operated using a trapezoidal block of a drive voltage, in certain operating states it may arise that, owing to the voltage induction caused by the movement of the rotor, a current flows in a direction opposite the desired current direction. This likewise has considerable disadvantages in respect of the noise development and also the efficiency and control quality of such an electric machine are impaired.

Therefore, the object of the present invention is to provide a method and a device for driving an electronically commutated electric machine which are easy to implement and also reduce noise development, in particular as a result of a current in a negative flow direction relative to the applied drive voltage resulting from the voltage induction.

### SUMMARY OF THE INVENTION

This object is achieved by the method for driving an electronically commutated electric machine and by the apparatus, the drive system and the computer program product.

In accordance with a first aspect, a method for operating a polyphase electric machine is provided, wherein, corresponding to a preset commutation method, drive voltages to be applied to phase windings of the electric machine are provided. When a sudden change in state, determined by the preset commutation method, from a state in which one of the phase windings is switched to the de-energized state to a state in which the drive voltage is applied to the relevant phase winding is established, the following steps are implemented:
directly applying a provided intermediate voltage;
applying a voltage profile, which results from a preset continuous time profile of the intermediate voltage with respect to the drive voltage of the relevant phase winding, until the drive voltage to be applied is reached.

In accordance with a further aspect, a method for operating a polyphase electric machine is provided, wherein, corresponding to a preset commutation method, drive voltages to be applied to phase windings of the electric machine are provided. When a sudden change in state, determined by the preset commutation method, from a state in which one of the drive voltages is applied to the corresponding phase windings to a state in which the relevant phase winding is switched to the de-energized state is established, the following steps are implemented:
applying a voltage profile, which results from a preset continuous time profile of the drive voltage with respect to the intermediate voltage of the relevant phase winding, until the intermediate voltage is reached,
as soon as the voltage has reached the intermediate voltage, directly switching the phase winding to the de-energized state.

In accordance with a further aspect, a method for operating a polyphase electric machine having the steps of the above methods is provided.

One concept of the above methods consists in forming the edges occurring in the event of a change in state such that, during switching from a de-energized state, a provided intermediate voltage is applied suddenly or, during switching to a de-energized state, this is assumed by the provided intermediate voltage. The voltage profile between the applied drive voltage and the intermediate voltage or between the intermediate voltage and the drive voltage to be applied is preset by a limited gradient in accordance with a preset time profile.

In this way, firstly the advantages of block commutation and trapezoidal commutation are combined with one another such that reduced running noise of the electric machine is achieved. Secondly, the disadvantages which result in respect of efficiency and control quality owing to a motor current which is in the opposite direction to the voltage direction are reduced.

Furthermore, the time profile can be provided such that the gradient of the change in voltage does not at any point in time exceed a maximum gradient in terms of absolute value.

In particular, the time profile can be preset as a linear profile.

Provision can be made for the intermediate voltage to correspond to a preset component of the drive voltage applied or the drive voltage to be applied. In particular, the intermediate voltage can be limited to a minimum intermediate voltage value and/or a maximum intermediate voltage value.

In accordance with a further embodiment, the commutation method can correspond to block commutation.

Furthermore, the commutation method can correspond to sinusoidal commutation, wherein in order to provide a blanking interval for measuring an induced voltage at the relevant phase winding, a change in state from or to a de-energized state is provided.

In accordance with a further aspect, a device for operating a polyphase electric machine is provided, wherein the device is designed to implement one of the above methods.

In accordance with a further aspect, a computer program product is provided, which contains a program code which, when it is run on a data processing device, implements the above method.

### BRIEF DESCRIPTION OF THE DRAWINGS

Preferred embodiments of the present invention will be explained in more detail below with reference to the attached drawings, in which:

FIG. 1 shows a schematic illustration of a drive system with an electronically commutated electric machine;

FIG. 2 shows a flowchart illustrating the drive method for operating the electric machine in the drive system shown in FIG. 1; and

FIG. 3 shows the profile of a drive voltage which results during operation of the electric machine in accordance with the method shown in FIG. 2.

### DETAILED DESCRIPTION

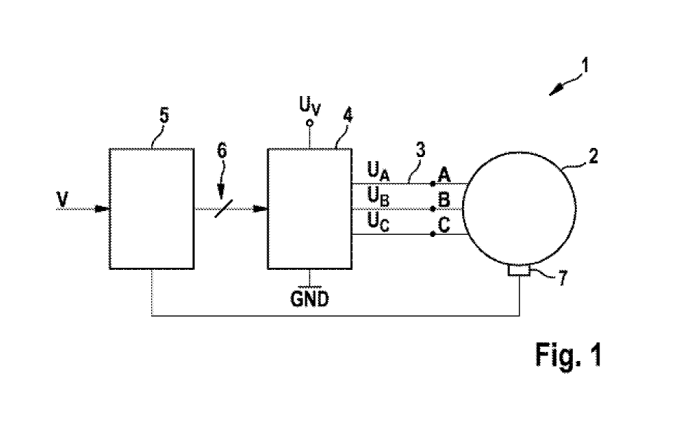

FIG. 1 shows a drive system 1 with an electric machine 2, which in the present case is in the form of a three-phase electronically commutated electric machine. The electric machine 2 has three phase connections 3, via which drive voltages U_{A}, U_{B}, U_{C} are applied to the electric machine 2.

The drive voltages U_{A}, U_{B}, U_{C} are provided by a driver circuit 4. The provision of the drive voltages U_{A}, U_{B}, U_{C} is controlled by the control unit 5. The control unit 5 determines a commutation method in accordance with which the driver circuit 4 is driven in order to apply a specific pattern of drive voltages U_{A}, U_{B}, U_{C} to the electric machine 2.

The driver circuit 4 can be designed, for example, with a so-called B6 circuit, in which three series circuits, connected in parallel with one another, and each having two power semiconductor switches are used. The power semiconductor switches can comprise power MOSFETs, thyristors, IGBTs, IGCTs or the like. The corresponding drive voltages U_{A}, U_{B}, U_{C} can be tapped off at nodes between the two series-connected power semiconductor switches in the series circuits, or each node is connected to one of the phase connections 3, associated therewith, of the electric machine 2 in order to apply the corresponding drive voltages U_{A}, U_{B}, U_{C}.

Corresponding to the driving of the power semiconductor switches in the driver circuit 4 by the control unit 5, a provided high supply potential U_{V} or a provided low supply potential GND is applied to the phase connections 3 correspondingly or the relevant phase connection 3 is switched to the de-energized state. The driving of the driver circuit 4 by the control unit 5 takes place in accordance with a preset for a torque indication V, by virtue of which an indication of a torque to be made available by the electric machine 2 is preset to the control unit 5. The control unit 5 converts the torque indication V into a corresponding switching pattern, which is applied to the driver circuit 4 via the control lines 6. The switching pattern determines the drive voltages U_{A}, U_{B}, U_{C} to be generated and applied by the driver circuit 3.

The control unit 5 determines the switching pattern corresponding to the torque indication V and a position of a rotor of the electric machine 2. In particular, the commutation times at which the switching pattern for the driver circuit 4 is changed are determined depending on the rotor position. The rotor position can be detected with the aid of a position sensor 7 or else by sensorless position detection methods known from the prior art, which can be based on, for example, the measurement of connection voltages of the electric machine 2 at phase connections 3 which are switched to the de-energized state.

Furthermore, the control unit 5 can be designed to preset the drive voltages U_{A}, U_{B}, U_{C} with a voltage value which is between the high supply potential U_{V} and the low supply potential GND. For this, the control unit can provide the respective voltage value with the aid of pulse width modulation. The torque indication V is then used to determine a duty factor for the pulse width modulation and, corresponding to the switching pattern, to apply the pulse-width-modulated drive voltage U_{A}, U_{B}, U_{C} to the relevant drive connection of the electric machine 2 or not.

If trapezoidal block commutation of the electric machine 2 is intended to be performed by the control unit 5, provision can furthermore be made for, at the beginning of a time window after a change in the switching pattern, i.e. at a time at which a change in the drive voltage U_{A}, U_{B}, U_{C} to be applied at a phase connection 3 is intended to be performed, the effective drive voltage U_{A}, U_{B}, U_{C} to be preset, beginning with the time of the change, by a continuous duty factor which rises over time in accordance with a preset time profile (in terms of absolute value). The preset time profile provides for the gradient not to exceed a maximum value in terms of absolute value at any point in time. The rise, in terms of absolute value, in the duty factor takes place until the duty factor corresponds to the duty factor for providing the desired drive voltage U_{A}, U_{B}, U_{C} determined with the aid of the torque indication V. At the end of the relevant time window during which a renewed change in the drive voltages U_{A}, U_{B}, U_{C} to be applied is present at at least one phase connection 3, the edge of the respective drive voltage U_{A}, U_{B}, U_{C} occurring as a result of the change can be formed correspondingly by continuously reducing (in terms of absolute value) the duty factor in accordance with a preset time profile. In this way, softer switchover of the magnetic field direction of the stator magnetic field can be achieved, which results in less noise development.

As mentioned at the outset, the trapezoidal block commutation can result, however, in an induced voltage in a phase winding being produced by voltage induction owing to the movement or rotation of the rotor in the stator magnetic field, which induced voltage results in a current in the relevant stator windings with an opposite current direction with respect to a drive voltage U_{A}, U_{B}, U_{C} of the relevant phase winding which is applied or to be applied. This results in increased noise development and, in addition, the efficiency and control quality for such a drive system are impaired.

In order to avoid these disadvantages, a commutation method is now provided in which current flows in the phase windings of the electric machine 2 with current directions which are opposite the drive voltage U_{A}, U_{B}, U_{C} can largely be avoided.

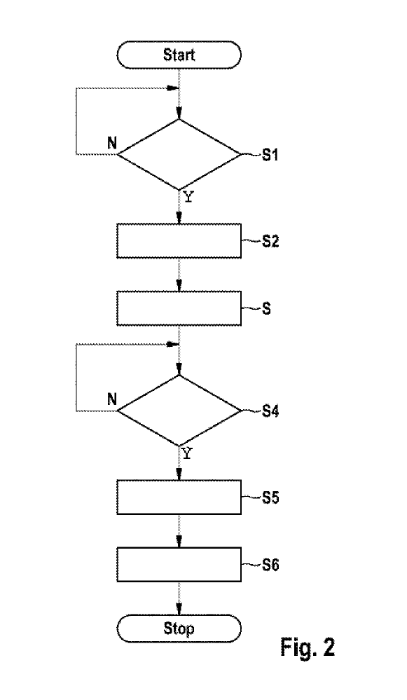

The method for providing the drive voltages is described in more detail with reference to the flowchart in FIG. 2.

The starting situation is the operation of the electric machine with a commutation method in which sudden voltage changes in the drive voltages at the phase connections 3 can occur.

If it is detected, in a step S1, corresponding to the selected commutation method, that a voltage value for a drive voltage U_{A}, U_{B}, U_{C} is intended to be applied which would result in a sudden change in the relevant drive voltage U_{A}, U_{B}, U_{C} (alternative: yes), an intermediate voltage which is smaller in terms of absolute value than the desired drive voltage U_{A}, U_{B}, U_{C} is applied by virtue of presetting a corresponding duty factor at the time of the sudden change (detection time in step S1) (step S2). In particular, in step S1, a change in state is identified in which the relevant drive voltage is intended to be applied to a phase connection 3 which has previously been switched to the de-energized state. “De-energized” or “switched to the de-energized state” means that the phase connection 3 is connected neither to the high supply potential U_{V} nor to the low supply potential GND. The level of the intermediate voltage U_{Z} can be determined in a variety of ways.

1. The intermediate voltage U_{Z} results as component f of the drive voltage U_{A2}, U_{B2}, U_{C2} to be applied. The component f can be, for example, between 40 and 60% of the drive voltage to be applied, in particular 50% of the drive voltage U_{A2}, U_{B2}, U_{C2} to be applied. The following then applies for the phase winding of phase A:

U_{Z}=U_{A2}*f

2. The intermediate voltage U_{Z} results from a fixedly preset intermediate voltage U_{Zfix}, wherein the intermediate voltage U_{Z} corresponds to the fixedly preset intermediate voltage U_{Zfix} (maximum intermediate voltage value) when the desired drive voltage U_{A2}, U_{B2}, U_{C2} to be applied is now greater in terms of absolute value than the fixedly preset intermediate voltage U_{Zfix} and wherein the intermediate voltage U_{Z} corresponds to the component f of the drive voltage U_{A2}, U_{B2}, U_{C2} to be applied when the drive voltage U_{A2}, U_{B2}, U_{C2} to be applied is lower than the preset intermediate voltage U_{Z}. The following then applies for the phase winding of the phase A:

U_{Z}=U_{A2}*f for |U_{A2}|>|U_{Z}|

U_{Z}=U_{Zfix} for |U_{A2}|<|U_{Z}|

3. The intermediate voltage U_{Z} corresponds to a preset intermediate voltage U_{Zfix} wherein the intermediate voltage U_{Z} corresponds to the drive voltage U_{A2}, U_{B2}, U_{C2} to be applied when the drive voltage U_{A2}, U_{B2}, U_{C2} is lower than the preset intermediate voltage U_{Zfix}.

The intermediate voltage U_{Z} is preset in accordance with a duty factor. In a step S3, the duty factor is now increased continuously from the duty factor of the intermediate voltage U_{Z} to the duty factor of the drive voltage U_{A2}, U_{B2}, U_{C2} to be applied in accordance with a preset time profile wherein the gradient of the increase is limited, in terms of absolute value, to a preset maximum gradient. In particular, the increase in the duty factor can be performed linearly. As a result, the duty factor is now maintained for the preset time period of the time window determined by the block commutation, during which the drive voltage U_{A2}, U_{B2}, U_{C2} to be applied is intended to be applied.

If it is detected, in step S4, that the time window for the application of the desired drive voltage U_{A2}, U_{B2}, U_{C2} has come to an end (alternative: yes) or an end of the time window is directly immanent, the applied drive voltage U_{A1}, U_{B1}, U_{C1} (corresponds to U_{A2}, U_{B2}, U_{C2} in step S3) is first reduced from the drive voltage U_{A2}, U_{B2}, U_{C2} now to be applied, in terms of absolute value, to an intermediate voltage U_{Z} determined to one of the above calculation rules by virtue of reducing the duty factor (step S5) before the relevant phase connection 3 is switched to the de-energized state directly (step S6). In particular, in step S4, a change in state is identified in which the phase connection at which the relevant drive voltage is present is intended to be switched to the de-energized state.

Thus, the method for applying a drive voltage U_{A2}, U_{B2}, U_{C2} to be applied to a phase connection 3 of the electric machine 2 for a drive block of a phase connection 3 is ended. The above method can be used for one or more or all phase connections 3 of the electric machine 2. It can be used both only for the edge rising in terms of absolute value (beginning of the time window) and only for the falling edge (end of the time window).

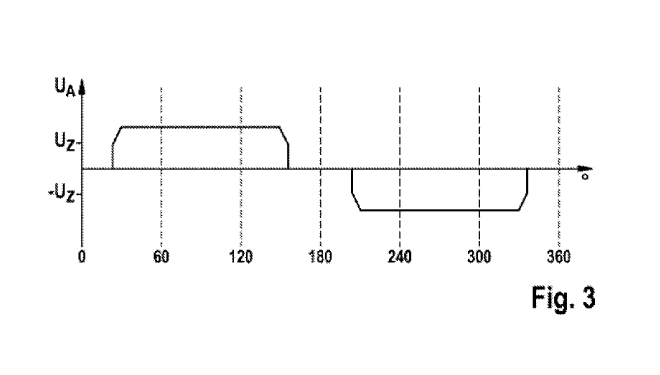

FIG. 3 illustrates a voltage/time graph illustrating the profile of a drive voltage of phase A in accordance with a block commutation method, by way of example. The initially sudden change is identified at the commutation time when the phase connection of the phase A is intended to be brought from a de-energized state into a state in which the drive voltage U_{A} is applied. After the sudden rise to the intermediate voltage U_{Z}, the further (flatter) rise with a gradient which is limited to the maximum gradient then takes place.

Furthermore, the change is identified at a commutation time when the phase connection of the phase A is intended to be brought from a state in which the drive voltage U_{A} is applied to a de-energized state. First, the drive voltage falls with a gradient which is limited in terms of absolute value and then it is set to a de-energized state when the intermediate voltage U_{Z} is reached.

It is furthermore possible to use the relevant method not only in drive methods with block commutation, but also in other commutation methods, for example when sudden changes in the drive voltages occur in the event of the provision of a blanking interval for the measurement of an induced voltage in the de-energized state. In order to avoid noise development and other desired effects owing to the sudden changes in voltage at the phase windings, in particular the occurrence of a negative current flow with respect to the desired drive voltage, the increase and reduction of the duty factor in accordance with a desired drive voltage can likewise first be performed until an intermediate voltage U_{Z} is reached, and then the gradient of the change in the applied drive voltage can be limited to a preset maximum gradient.

1. A method for operating a polyphase electric machine (2), wherein, corresponding to a preset commutation method, drive voltages (U_{A}, U_{B}, U_{C}) to be applied to phase windings of the electric machine (2) are provided, wherein, when a sudden change in state, determined by the preset commutation method, from one state in which one of the phase windings is switched to the de-energized state to a state in which the drive voltage (U_{A}, U_{B}, U_{C}) is applied at the relevant phase winding is established, the method comprising:
directly applying a provided intermediate voltage (U_{Z}); and
applying a voltage profile, which results from a preset continuous time profile of the intermediate voltage (U_{Z}) with respect to the drive voltage (U_{A}, U_{B}, U_{C}) of the relevant phase winding, until the drive voltage (U_{A}, U_{B}, U_{C}) to be applied is reached.

2. A method for operating a polyphase electric machine (2), wherein, corresponding to a preset commutation method, drive voltages to be applied to phase windings of the electric machine are provided, wherein, when a sudden change in state, determined by the preset commutation method, from a state in which one of the drive voltages (U_{A}, U_{B}, U_{C}) is applied to the corresponding phase windings to a state in which the relevant phase winding is switched to the de-energized state is established, the method comprising:
applying a voltage profile, which results from a preset continuous time profile of the drive voltage (U_{A}, U_{B}, U_{C}) with respect to the intermediate voltage (U_{Z}) of the relevant phase winding, until the intermediate voltage U_{Z} is reached, and
as soon as the voltage has reached the intermediate voltage, directly switching the phase winding to the de-energized state.

3. (canceled)

4. The method as claimed in claim 1, wherein the time profile is envisaged such that the gradient of the change in voltage does not at any point in time exceed a maximum gradient in terms of absolute value.

5. The method as claimed in claim 4, wherein the time profile is preset as a linear profile.

6. The method as claimed in claim 1, wherein the intermediate voltage (U_{Z}) corresponds to a preset component of the drive voltage (U_{A}, U_{B}, U_{C}) applied or the drive voltage (U_{A}, U_{B}, U_{C}) to be applied.

7. The method as claimed in claim 6, wherein the intermediate voltage (U_{Z}) is limited to a minimum intermediate voltage value and/or a maximum intermediate voltage value.

8. The method as claimed in claim 1, wherein the commutation method corresponds to block commutation.

9. The method as claimed in claim 1, wherein the commutation method corresponds to sinusoidal commutation, wherein in order to provide a blanking interval for measuring an induced voltage at the relevant phase winding, a change in state from or to a de-energized state is provided.

10. A device for operating a polyphase electric machine (2), wherein the device is designed to implement one of the methods as claimed in claim 1.

11. A computer program product which contains a program code which, when it is run on a data processing device, implements the method as claimed in claim 1.

12. The method as claimed in 2, wherein the time profile is envisaged such that the gradient of the change in voltage does not at any point in time exceed a maximum gradient in terms of absolute value.

13. The method as claimed in claim 12, wherein the time profile is preset as a linear profile.

14. The method as claimed in claim 2, wherein the intermediate voltage (U_{Z}) corresponds to a preset component of the drive voltage (U_{A}, U_{B}, U_{C}) applied or the drive voltage (U_{A}, U_{B}, U_{C}) to be applied.

15. The method as claimed in claim 14, wherein the intermediate voltage (U_{Z}) is limited to a minimum intermediate voltage value and/or a maximum intermediate voltage value.

16. The method as claimed in claim 2, wherein the commutation method corresponds to block commutation.

17. The method as claimed in claim 2, wherein the commutation method corresponds to sinusoidal commutation, wherein in order to provide a blanking interval for measuring an induced voltage at the relevant phase winding, a change in state from or to a de-energized state is provided.

18. A device for operating a polyphase electric machine (2), wherein the device is designed to implement one of the methods as claimed in claim 2.

19. A computer program product which contains a program code which, when it is run on a data processing device, implements the method as claimed in claim 2.

20. The method as claimed in claim 1, further comprising:
applying a voltage profile, which results from a preset continuous time profile of the drive voltage (U_{A}, U_{B}, U_{C}) with respect to the intermediate voltage (U_{Z}) of the relevant phase winding, until the intermediate voltage U_{Z} is reached, and
as soon as the voltage has reached the intermediate voltage, directly switching the phase winding to the de-energized state.
